(19) United States
(12) Patent Application Publication
(10) Pub. No.: US 2019/0375291 A1
(43) Pub. Date: Dec. 12, 2019

(54) MOTOR VEHICLE TANK SUBASSEMBLY HAVING A FILTER BODY THAT ENHANCES WITHDRAWAL RELIABILITY, AND SUCH A FILTER BODY

(71) Applicant: Röchling Automotive SE & Co. KG, Mannheim (DE)

(72) Inventors: Ivan De Metri, Bolzano (IT); Fabrizio Chini, Isera (IT); Elmar Pichler, Ritten (IT)

(21) Appl. No.: 16/430,753

(22) Filed: Jun. 4, 2019

(30) Foreign Application Priority Data
Jun. 6, 2018 (DE) 10 2018 113 471.1

(51) Int. Cl. B60K 15/077; B01D 29/11; B01D 35/14

(52) U.S. Cl. CPC B60K 15/077; B60K 2015/0777; B01D 35/14; B01D 29/114

(57) ABSTRACT

A motor vehicle tank subassembly for storing and discharging an operating liquid, encompassing: a tank shell enclosing a tank interior; a conveying pump; a filter body at least partly accessible from the tank interior; and an intake conduit, the filter body having a body shell that encloses a filter body interior; at least a portion of the body shell encompassing a liquid-permeable filter material through which operating liquid in the tank interior can flow from outside the filter body into the filter body interior; the intake conduit connecting an intake side of the conveying pump to the filter body interior; arranged in the filter body interior, in the region of an intake opening of the intake conduit, is a baffle configuration that is embodied, as compared with an identically constructed filter body having no baffle configuration, to impede a movement of operating liquid away from the intake opening.

The present invention relates to a motor vehicle tank subassembly for storing and discharging an operating liquid, encompassing: a tank shell enclosing a tank interior; a conveying pump; a filter body at least partly accessible from the tank interior; and an intake conduit, the filter body comprising a body shell that encloses a filter body interior; at least a portion of the body shell encompassing a liquid-permeable filter material through which operating liquid in the tank interior can flow from outside the filter body into the filter body interior; the intake conduit connecting an intake side of the conveying pump to the filter body interior.

A motor vehicle tank subassembly of the species is known from DE 10 2012 003 121 A1 or also from DE 10 2010 014 314 A1.

The present invention furthermore relates to a filter body encompassing a body shell that encloses a filter body interior, the body shell comprising a cage shell having openings that pass through it and are covered with filter material; the outer side of the body shell comprising a coupling configuration for pressure-transferring and liquid-conveying coupling of an intake conduit; the coupling configuration comprising an intake opening passing through the body shell.

A filter body of this kind is also known from DE 10 2012 003 121 A1.

### BACKGROUND OF THE INVENTION

The tank subassemblies known from the aforesaid documents have in common the fact that the filter bodies used in the tank subassemblies comprise a relatively large filter body interior in which operating liquid, after passing through openings in the body shell which are covered with filter material, can be retained over a longer period of time even if external forces act on the operating liquid, for example because the vehicle carrying the tank subassembly moves acceleratingly.

In the case of DE 10 2010 014 314 A1, the conveying pump as well as further functional units are in fact received in the filter body interior.

Filter body interiors of this kind, which are surrounded by a body shell comprising filter material, are advantageous in that operating liquid penetrates through the filter material only when there exists between the two sides of the filter material, i.e. the inner side facing toward the filter body interior, and the outer side facing toward the external environment, of the filter material, a pressure difference sufficient to overcome the penetration resistance generated by the filter material.

In a tank interior that has previously been emptied and has been maximally filled after being emptied, this pressure difference can be generated by the hydrostatic pressure of the operating liquid introduced into the tank interior, which liquid can be located, upon an emptying of the tank interior, and thus also of the filter body interior, immediately after refilling of the tank interior, at first exclusively outside the filter body. The conformation of the tank interior, in particular the fill height of the operating liquid above the filter body, determines whether the hydrostatic pressure is sufficient in this context.

The pressure difference can be generated very reliably by the conveying pump whose intake side is connected via the intake conduit to the filter body interior, so that a vacuum generated on the intake side by the conveying pump, with reference to the ambient pressure also present in a gas space above the operating liquid introduced into the tank interior, acts in the filter body interior.

As operating liquid is increasingly withdrawn from the tank interior, the operating liquid still remaining in the tank interior becomes increasingly susceptible to being displaced in the tank interior by external forces. The result is that the lower the fill level within the tank interior, the more readily an accelerated motion of the tank shell, and thus of the operating liquid stored therein, results in a motion of the operating liquid in the tank interior. In a context, for example, of extended cornering or a long period of acceleration from a standstill to a high travel speed, this can lead to problems in terms of continuous withdrawal of operating liquid from the tank shell.

The filter body interior already offers enhanced withdrawal reliability because once operating liquid has been taken into the filter body interior through the filter material of the body shell, as a rule it does not experience acceleration forces sufficient to cause the operating liquid to penetrate again through the filter material and thus be forced out of the filter body interior. A first improvement in withdrawal reliability is therefore achieved by the fact that the filter body interior is substantially smaller than the tank interior, and operating liquid is taken into and withdrawn from the filter body interior only after previous filtering. Operating liquid that has flowed into the filter body interior thus has less room available for it to move therein than in the tank interior.

When so much operating liquid has been withdrawn from the tank interior that even the filter body interior is no longer completely filled with operating liquid, however, the risk also exists, upon intake of operating liquid from the filter body interior, that in the driving situations recited above with extended acceleration phases, the operating liquid may become and remain forced away from an intake opening, located remotely from the conveying pump, of the intake conduit. Withdrawal of filtered operating liquid is then no longer possible, or at least not continuously ensured, for the duration of the acceleration phase.

### SUMMARY OF THE INVENTION

An object of the present invention is therefore to furnish a technical teaching that refines the tank subassembly recited previously and the filter body recited previously in such a way that even in the event of longer-duration acceleration phases, the reliability with which operating liquid is withdrawn from the tank subassembly is enhanced as compared with the existing art.

In accordance with a first aspect of the present invention this object is achieved by a motor vehicle tank subassembly of the kind recited previously in which there is arranged in the filter body interior, in the region of an intake opening of the intake conduit, a baffle configuration that is embodied, as compared with an identically constructed filter body having no baffle configuration, to impede a movement of operating liquid away from the intake opening.

In accordance with a second aspect of the present invention this object is furthermore achieved by a filter body of the kind recited previously in which there is arranged on the inner side of the body shell in the region of the intake opening, preferably partly surrounding the intake opening, a baffle configuration that is embodied, as compared with an identically constructed filter body having no baffle configuration, to impede a movement of liquid in the filter body interior away from the intake opening.

The result of the baffle configuration is to impede the movement of operating liquid, which in the absence of external forces (except for the unavoidable effect of gravity) is uniformly distributed in the filter body interior over its base surface, away from the intake opening, so that sufficient operating liquid is present in the region of the intake opening of the intake conduit even when acceleration forces, due to cornering and/or due to changes in absolute acceleration values, act on the operating liquid in the filter body interior.

A period of approximately 20 seconds of effect of such acceleration forces is already considered long, since in most cases a curve should be negotiated in 20 seconds or a desired final speed should be reached in 20 seconds starting from an initial speed.

The baffle configuration can in principle be any configuration that impedes a flow of operating liquid. It is preferably passive and is not constituted by functional components having a function other than baffling, for example the conveying pump, a quality sensor, and the like. For example, the baffle can encompass a fiber web that is arranged in the filter body interior. It is advantageous in that case to line as much as possible of the bottom surface, i.e. that surface which is wetted with operating liquid when only gravitational force is acting and when the filter body interior is only partly filled, with fiber web, in order to achieve maximally uniform impedance of a flow of operating liquid along the bottom surface.

The use of fiber web in the filter body interior can result, however, in an undesirably large volume being occupied by the fibers of the fiber web, that volume then no longer being available for the reception of operating liquid in the filter body interior. It is therefore preferred, in order to make available in the filter body interior the largest possible volume for the reception of operating liquid, that the baffle configuration encompass a wall that projects from the body shell into the filter body interior. It is then sufficient for such a wall to be present only in the region of the intake opening, while regions located farther from the intake opening can be devoid of such walls or of the baffle configuration as a whole.

The at least one wall of the baffle configuration can be singly or multiply curved and/or inflected.

The intake opening is preferably arranged in the bottom surface of the body shell of the filter body, since it is wetted for the longest time with operating liquid upon withdrawal of operating liquid from the filter body interior. It is then preferred if the at least one wall protrudes into the filter body interior from the bottom surface oppositely to the direction of gravity. For additional impedance of the movement of operating liquid, the at least one wall can be singly or multiply curved or inflected, in particular around one or several axis/axes of curvature or of inflection which are parallel to the direction of gravity.

Because the problem of undesired movement of the operating liquid occurs, in the filter body interior as well, only as the fill level in the filter body interior decreases, i.e. when the filter body interior is only partly filled, and increases with further withdrawal, it is sufficient if the at least one wall extends in the region of the intake opening protrudingly to half the height of the filter body interior, at least to a third of the interior height of the filter body interior. As much as possible of the filter body interior's volume is thus available for the reception of operating liquid. Protrusion to greater heights, i.e. a closer approach to a ceiling surface, located oppositely from the bottom surface, of the filter body interior, is nevertheless not to be excluded.

Although a curved, optionally multiply curved, and/or singly or multiply inflected, baffle wall already allows impedance of the movement of operating liquid in the region of the intake opening to be achieved, even more pronounced immobilization of operating liquid in the region of the intake opening can be achieved by the fact that the baffle configuration encompasses a plurality of walls that project from the body shell into the filter body interior and are arranged with a spacing from one another in such a way that a continuous flow path, from a location farther from the intake opening past walls to the intake opening, exists for operating liquid in the filter body interior. The statements made above regarding the at least one wall apply correspondingly to each individual one of these walls.

Walls from among the plurality of walls preferably overlap in a circumferential direction around an intake axis passing centrally through the intake opening. For example, the at least one wall of the baffle configuration can constitute a labyrinth that offers a flow path to the intake opening but deflects it sufficiently often that a movement away from the intake opening is greatly impeded. The flow path does not need to exist directly on the bottom of the filter body, but instead can be implemented starting 3 to 5 millimeters above the filter body bottom. Preferably, however, the flow path exists over the entire height of the baffle configuration.

For clarification, the term “in the region of the intake opening” is intended to mean that the baffle configuration, in particular the at least one wall, is provided in a zone around the intake opening which has a radial extent, with reference to an intake axis passing centrally through the intake opening, of no more than six times the diameter of the intake opening, preferably no more than 3.5 times the diameter of the intake opening. The diameter of the zone is therefore at most twelve times, preferably at most seven times, the diameter of the intake opening.

In order to allow the largest possible opening area of the body shell to be furnished for the passage of operating liquid through the filter material of the body shell, the body shell can comprise a cage shell having penetrating openings. The openings can be equipped, if necessary, with crossmembers, for example vertical, transverse, or diagonal struts. The filter material is then preferably arranged to cover the openings so that operating liquid, driven by a corresponding pressure gradient, always flows also through the filter material along with the openings of the body shell. The result is that only sufficiently purified operating liquid reaches the intake opening.

The filter material can be connected in positively engaged fashion to the body shell and/or can be connected adhesively thereto. The filter material can be arranged on the inner side of the body shell facing toward the intake opening, or on the outer side of the body shell facing toward the tank interior. In addition, for optimum mechanical support of the filter material with respect to the liquid pressure acting on it, a respective support structure can be provided on the outer side facing toward the tank interior, and on the inner side facing toward the intake opening, of the filter material. In this case the body shell is constituted by two body structures, arranged with a spacing from one another, between which the filter material is arranged.

For maximally efficient utilization of the filter body interior for the reception of operating liquid, the filter body interior is preferably hollow except for the baffle configuration. Preferably, therefore, no functional components, for example the conveying pump, are arranged in the filter body interior. The filter body interior can, however, comprise a planar heating apparatus, for example a heating film or resistance heating traces arranged on an inner surface of the body shell, so that operating liquid received in the filter body interior can be kept in a liquid aggregate state ready for withdrawal.

For maximally simple but secure arrangement of the filter body in or on the tank body, at least one fastening configuration for connection to a carrying structure can be provided on the outer side of the body shell. The carrying structure can be, for example, the tank body or can be a withdrawal module. The withdrawal module encompasses, as a preinstalled subassembly, an installation plate that carries the conveying pump.

The invention further refers to a motor vehicle having a tank subassembly embodied as described above.

These and other objects, aspects, features and advantages of the invention will become apparent to those skilled in the art upon a reading of the Detailed Description of the invention set forth below taken together with the drawings which will be described in the next section.

### BRIEF DESCRIPTION OF THE DRAWINGS

The invention may take physical form in certain parts and arrangement of parts, a preferred embodiment of which will be described in detail and illustrated in the accompanying drawings which form a part hereof and wherein:

FIG. 1 is a schematic longitudinal section view through an embodiment according to the present invention of a motor vehicle tank subassembly; and

FIG. 2 is a schematic cross-sectional view, along plane II-II of FIG. 1, through the filter body of the tank subassembly of FIG. 1.

### DESCRIPTION OF PREFERRED EMBODIMENTS

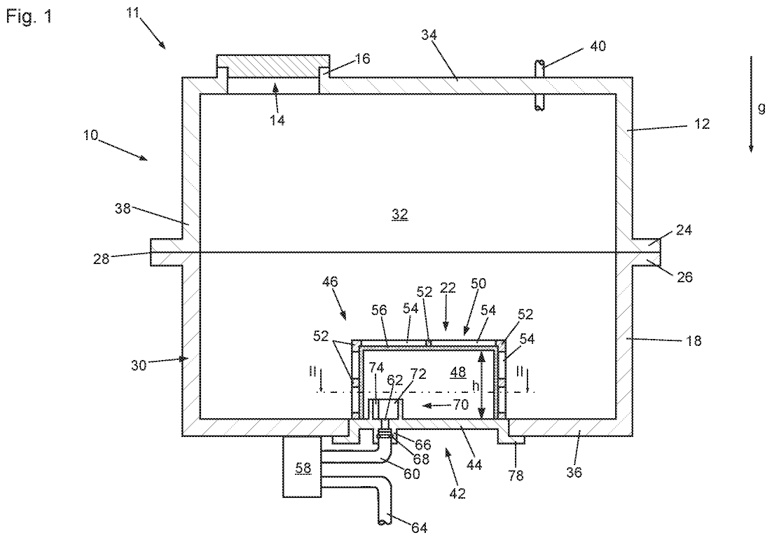

Referring now to the drawings wherein the showings are for the purpose of illustrating preferred and alternative embodiments of the invention only and not for the purpose of limiting the same, in FIG. 1, a liquid tank of a motor vehicle tank subassembly 11 according to the present invention is labeled in general with the number 10. Liquid tank 10 preferably encompasses an upper shell part 12 that comprises a filling opening 14 having a flange rim 16 that surrounds filling opening 14. A filling conduit, for example a filler tube (not depicted in FIG. 1), can be attached to flange rim 16. Filling opening 14, or the filling conduit if present, can preferably be closed off by a cover 17.

Liquid tank 10 furthermore encompasses a lower shell part 18 that comprises an installation opening 20 having a filter body 22 that is inserted into installation opening 20 and closes it off.

Upper shell part 12 and lower shell part 18 are joined to one another, for example adhesively bonded or welded, preferably along respective encircling joining flanges 24, 26. Joining flanges 24 and 26 touch one another along a joining surface 28 that is preferably flat.

Tank 10 comprises a tank shell 30 that surrounds a tank interior 32 of tank 10 which furnishes a tank volume. Tank shell 30 encompasses a tank ceiling 34, a tank bottom 36 located oppositely from tank ceiling 34, and a surrounding tank side wall 38 that connects tank ceiling 34 and tank bottom 36.

Tank shell 30 can of course, unlike in the example depicted, comprise more than two shell parts 12 and 18, or can also be formed as a single part, for example by blow molding.

Lower shell part 18, like upper shell part 12, is preferably manufactured by injection molding.

By means of a vent conduit 40 passing through tank ceiling 34, gas present in tank 10 can flow out as operating liquid is introduced thereinto, and gas can flow in as operating liquid is withdrawn from tank 10. Gas that is unavoidably contained in tank 10, in particular air, is therefore at approximately ambient pressure.

Arrow g indicates the orientation of tank 10 with reference to the direction of gravity, in the completed state installed in a motor vehicle. As a result of this orientation, in the absence of external forces (with the exception of gravity), operating liquid will collect on tank bottom 36.

The withdrawal of operating liquid from tank 10 is accomplished through the aforementioned withdrawal module 22. It comprises a body shell 42 having a bottom plate 44 and a hood-shaped upper part 46. Bottom plate 44 is inserted into installation opening 20 and connected to tank bottom 36, for example by adhesive bonding or plastic welding. Bottom plate 44 is thus connected in liquid-tight fashion to installation opening 20.

A substantially hollow filter body interior 48 is constituted between bottom plate 44 and hood-shaped upper part 46.

Upper part 46 encompasses a cage shell portion 50 that is constituted in skeleton fashion from struts 52 between which are constituted large-area openings 54 that are covered by planar filter material 56 on the inner side of cage shell portion 50. Operating liquid that flows from inside tank interior 32, but outside filter body interior 48, through openings 54 into filter body interior 48 therefore must flow through the planar filter material 56 and in that context is purified, depending on the characteristics of filter material 56, in terms of particles and suspended material.

The driving force for a flow of operating liquid through filter material 56 into filter body interior 48 is the vacuum that is generated by a conveying pump 58 with respect to the gas pressure in tank interior 32 and is transferred into filter body interior 48 through an intake conduit 60 via an intake opening 62 in bottom plate 44.

Conveying pump 58 therefore takes in operating liquid exclusively from filter body interior 48 and supplies it via its delivery-side supply conduit 64 to a user (not depicted), for example an injection apparatus. The operating liquid is preferably an aqueous operating liquid, for example water or an aqueous urea solution, which is respectively injected in different ways into gas flows of an internal combustion engine in order to decrease the latter's pollutant emissions. Water is injected into the fresh mixture flow delivered to the internal combustion engine (water injection), while aqueous urea solution is injected into the exhaust gas flow carried away from the internal combustion engine (selective catalytic reduction).

Bottom plate 44 has for this purpose a coupling configuration 66 that enables intake conduit 60 to be coupled on in known fashion. Coupling configuration 66 can be any conduit coupling for connecting and disconnecting conduit ends and/or housings. An elastomeric sealing ring 68 seals the coupling point between coupling configuration 66 and intake conduit 60, and preferably additionally ensures positively engaged latching coupling of intake conduit 60 to coupling configuration 66.

In order to enhance the withdrawal reliability of operating liquid from filter body interior 48, a baffle configuration 70 is constituted therein in the region of intake opening 62. Said configuration encompasses two walls 72 and 74 that protrude from bottom plate 44 into filter body interior 48 parallel to direction of gravity g, forming a rudimentary labyrinth. Walls 72 and 74 proceed from bottom plate 44 and extend over approximately one-third of the inside height h of filter body interior 48.

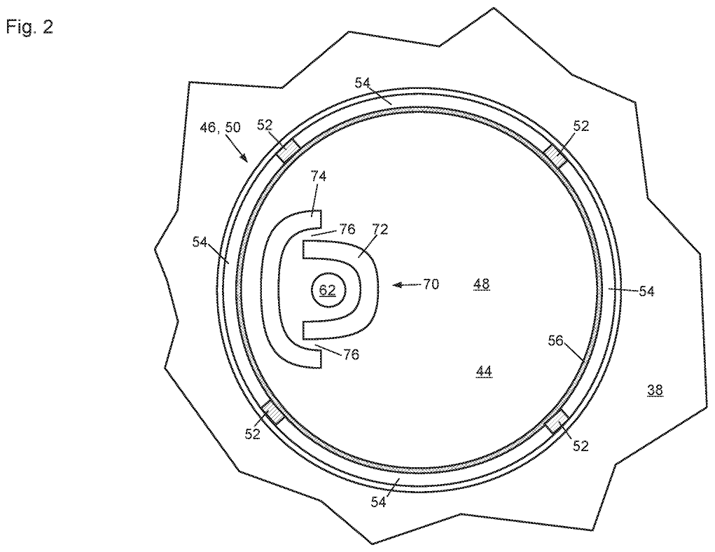

As is evident from FIG. 2, each of walls 72 and 74 extends partly around intake opening 62, each wall on a different side of intake opening 62. For that purpose, walls 72 and 74 are curved around axes of curvature parallel to direction of gravity g. Walls 72 and 74 overlap in a circumferential direction around intake opening 62, or around an intake axis that passes centrally through intake opening 62 and is orthogonal to the drawing plane of FIG. 2 and thus to bottom plate 44, forming a radial gap 76. Baffle configuration 70 is preferably manufactured in one piece with bottom plate 44, by injection molding or a similar primary forming procedure.

In weakly accelerated or unaccelerated driving states of a vehicle carrying tank subassembly 11, or when filter body interior 48 is completely filled, operating liquid arranged in filter body interior 48 is usually uniformly distributed over the entire area of bottom plate 44. When acceleration forces having a significant component orthogonally to direction of gravity g act on the operating liquid in the only partly filled filter body interior 48, walls 72 and 74, with their wall surfaces likewise oriented predominantly orthogonally to direction of gravity g, prevent a correspondingly strong acceleration of the operating liquid away from intake opening 62 in the region thereof. A portion of the operating liquid in filter body interior 48 located closer to intake opening 62 is thereby immobilized, and is available for removal through intake opening 62 by means of conveying pump 58 even in a context of acceleration forces that have an effective component orthogonal to direction of gravity g and have a longer duration (e.g. several seconds). The withdrawal reliability of tank subassembly 11 is thus enhanced as compared with the existing art.

The acceleration forces generated by driving dynamics of the vehicle that carries tank subassembly 11 are generally not of a magnitude sufficient to cause operating liquid to pass back out of filter body interior 48 through filter material 56.

Filter body interior 48 thus constitutes a first delimiting volume in which operating liquid is held close to intake opening 62. Inside filter body interior 48, baffle configuration 70 provides further immobilization of operating liquid in the region close to intake opening 62, if the liquid level in filter body interior 48 drops sufficiently that a surging movement of the operating liquid can be generated by smaller and smaller external forces.

A fastening configuration 78, for example an encircling flange, which facilitates liquid-tight placement of body shell 42 on tank shell 30, is provided on body shell 42, in the example depicted on bottom plate 44. Latching configurations, for example clips and the like, can also be embodied on body shell 42 in addition or alternatively to the flange shown merely by way of example.

While considerable emphasis has been placed on the preferred embodiments of the invention illustrated and described herein, it will be appreciated that other embodiments, and equivalences thereof, can be made and that many changes can be made in the preferred embodiments without departing from the principles of the invention. Furthermore, the embodiments described above can be combined to form yet other embodiments of the invention of this application. Accordingly, it is to be distinctly understood that the foregoing descriptive matter is to be interpreted merely as illustrative of the invention and not as a limitation.

1-10. (canceled)

11. A motor vehicle tank subassembly for storing and discharging an operating liquid, encompassing: a tank shell enclosing a tank interior; a conveying pump; a filter body at least partly accessible from the tank interior; and an intake conduit, the filter body comprising a body shell that encloses a filter body interior; at least a portion of the body shell encompassing a liquid-permeable filter material through which an associated operating liquid in the tank interior can flow from outside the filter body into the filter body interior; the intake conduit connecting an intake side of the conveying pump to the filter body interior,
wherein there is arranged in the filter body interior, in a region of an intake opening of the intake conduit, a baffle configuration that is embodied, as compared with an identically constructed filter body having no baffle configuration, to impede a movement of the associated operating liquid away from the intake opening.

12. The motor vehicle tank subassembly according to claim 11, wherein the baffle configuration encompasses a wall that projects from the body shell into the filter body interior.

13. The motor vehicle tank subassembly according to claim 11, wherein the baffle configuration encompasses a plurality of walls that project from the body shell into the filter body interior and are arranged with a spacing from one another in such a way that a continuous flow path, from a location farther from the intake opening past walls to the intake opening, exists for the associated operating liquid in the filter body interior.

14. The motor vehicle tank subassembly according to claim 13, wherein the plurality of walls of the baffle configuration constitutes a labyrinth.

15. The motor vehicle tank subassembly according to claim 12, wherein the wall of the baffle configuration constitutes a labyrinth.

16. The motor vehicle tank subassembly according to claim 11, wherein the intake opening is arranged in a bottom of the body shell.

17. The motor vehicle tank subassembly according to claim 11, wherein the body shell comprises a cage shell having penetrating openings, the liquid-permeable filter material being arranged to cover the openings.

18. The motor vehicle tank subassembly according to claim 11, wherein the filter body interior is hollow except for the baffle configuration.

19. The motor vehicle tank subassembly according to claim 11, wherein at least one fastening configuration for fastening to a carrying structure is arranged on the outer side of the body shell.

20. The motor vehicle tank subassembly according to claim 19, wherein the carrying structure is arranged on an outer side of the body shell.

21. The motor vehicle tank subassembly according to claim 19, wherein the carrying structure is the tank body or a withdrawal module.

22. The motor vehicle tank subassembly according to claim 21, wherein the withdrawal module encompasses, as a preinstalled subassembly, an installation plate that carries the conveying pump.

23. A filter body for use in a tank subassembly encompassing a body shell that encloses a filter body interior, the body shell comprising a cage shell having openings that pass through it and are covered with a liquid-permeable filter material; the outer side of the body shell comprising a coupling configuration for pressure-transferring and liquid-conveying coupling of an intake conduit; the coupling configuration comprising an intake opening passing through the body shell,
wherein there is arranged on an inner side of the body shell in a region of the intake opening a baffle configuration that is embodied, as compared with an identically constructed filter body having no baffle configuration, to impede a movement of liquid in the filter body interior away from the intake opening.

24. The filter body according to claim 23, wherein the baffle configuration partly surrounds the region of the intake opening.

25. The filter body according to claim 23, wherein the baffle configuration encompasses at least one wall that projects from the body shell into the filter body interior.

26. The filter body according to claim 25, wherein the at least one wall of the baffle configuration constitutes a labyrinth.

27. A motor vehicle having a tank subassembly according to claim 11.
